(19) United States
(12) Patent Application Publication
(10) Pub. No.: US 2023/0338869 A1
(43) Pub. Date: Oct. 26, 2023

(54) ELECTRICALLY CONDUCTIVE POROUS SINTERING BODY HAVING ELECTRICALLY CONDUCTIVE MATERIALS METHOD FOR PRODUCING

(71) Applicant: SCHOTT AG, Mainz (DE)

(72) Inventors: Dang Cuong PHAN, Aachen (DE); Matthias RINDT, Altfraunhofen (DE); Thomas BEERHORST, Altfraunhofen (DE)

(73) Assignee: SCHOTT AG, Mainz (DE)

(21) Appl. No.: 18/316,281

(22) Filed: May 12, 2023

Related U.S. Application Data
(63) Continuation of application No. PCT/EP21/82291, filed on Nov. 19, 2021.

(30) Foreign Application Priority Data
Nov. 19, 2020 (DE) 102020130560.5

(51) Int. Cl. B01B 1/00

(52) U.S. Cl. CPC B01B 1/005

(57) ABSTRACT

An evaporator that includes a porous sintering body is provided. The sintering body is made of a composite consisting of at least one first electrically conductive material and at least one second electrically conductive material as well as at least one dielectric material. The sintering body has an open porosity ranging from 10 to 90%, and the dielectric material is selected from the group consisting of crystallizable glass and/or glass ceramic, wherein the first electrically conductive material has a lower electric conductivity than the second electrically conductive material; the content of dielectric material in the composite equals 5 to 70 vol. %; the content of the first electrically conductive material in the composite equals 10 to 90 vol. %; the content of the second electrically conductive material equals 5 to 50 vol. %; and the sintering body has an electrical conductivity ranging from 0.1 to 105 S/m.

### CROSS REFERENCE TO RELATED APPLICATIONS

This application is a continuation of International Application PCT/EP2021/082291 filed Nov. 19, 2021, which claims benefit under 35 USC § 119 of German Application 10 2020 130 560.5 filed Nov. 19, 2020, the entire contents of all of which are incorporated herein by reference.

### BACKGROUND

### 1. Field of the Invention

The invention generally relates to an electrically conductive, porous sintered body. In particular, the invention relates to a vaporizer unit comprising a liquid store or liquid buffer and a heating unit for storage and controlled delivery of vaporizable substances. Here, the vaporizer unit can be used in particular in electronic cigarettes, in drug administration devices, room humidifiers and/or heatable evaporators. Here, the evaporators can be devices for provision, delivery and/or spreading of substances in a gas phase, for example in the room air, in the form of gases, vapors and/or aerosols. Substances that can be used are, for example, fragrances or active ingredients, in particular insect repellents.

### 2. Description of Related Art

Electronic cigarettes, also referred to hereinafter as e-cigarettes, or similar devices such as electronic pipes or shishas are being increasingly used as an alternative to tobacco cigarettes. Typically, electronic cigarettes comprise a mouthpiece and a vaporizer unit, and also an electrical power source operatively connected to the vaporizer unit. The vaporizer unit comprises a liquid store connected to a heating element.

Certain drugs, in particular drugs for the treatment of the respiratory tract and/or the oral mucosa and/or the nasal mucosa, are advantageously administered in a gaseous or vaporized form, for example as an aerosol. Vaporizers according to the invention can be used for storing and delivering such drugs, in particular in administration devices for such drugs.

Thermally heatable evaporators are increasingly being used to provide an environment with fragrances. In particular, these can be bars, hotel lobbies and/or vehicle interiors, for example the interiors of motor vehicles, in particular passenger vehicles. In the vaporizer unit used here, a liquid store is also connected to a heating element. The liquid store contains a liquid, which is usually a carrier liquid such as propylene glycol or glycerol, containing additives such as fragrances and flavorings and/or nicotine and/or drugs in a dissolved state and/or in general. The carrier liquid is bound on the inner surface of the liquid store by adsorption processes. Optionally, a separate liquid reservoir is provided in order to supply liquid to the liquid store.

In general, the liquid stored in the liquid store is vaporized by heating a heating element, desorbed from the wetted surface of the liquid store, and can be inhaled by the user. Temperatures of over 200° C. can be reached here.

The liquid store or liquid buffer must therefore have a high absorption capacity and a high adsorption effect, and at the same time the liquid must be delivered or transported quickly at high temperatures.

Different materials for use as liquid store or wick are known from the prior art. For instance, liquid stores or wicks can be formed by a porous or fibrous organic polymer. Although corresponding components can be produced quite easily, there is the risk here of, for example, excessive heating and decomposition of the polymeric material if the component runs dry. Not only does this have an adverse effect on the service life of the liquid store or wick and thus of the vaporizer unit, but there is also the risk of release of decomposition products of the fluid to be vaporized or even the liquid store and inhalation thereof by the user.

Electronic cigarettes having porous liquid stores composed of organic polymers are known from the prior art. Because of the low temperature stability of the polymeric material, it is therefore necessary to keep a minimum distance between the heating element and the liquid store. This prevents a compact design of the vaporizer unit and thus the electronic cigarette. As an alternative to keeping a minimum distance, use can be made of a wick which guides the liquid to be vaporized to the heating coil by capillary action. Said wick is usually made of glass fibers. Although these have a high temperature stability, the individual glass fibers can break easily. The same applies if the liquid store itself is also made of glass fibers. There is therefore a risk of the user inhaling loose or detached fiber fragments. Alternatively, wicks composed of cellulose fibers, cotton or bamboo fibers can also be used. Although these have a low risk of breakage compared to wicks composed of glass fibers, they are less temperature-stable.

Therefore, use is also made of vaporizer units, the liquid stores of which consist of porous glasses or ceramics. Because of the higher temperature stability of these liquid stores, a more compact design of the vaporizer and thus also the electronic cigarette as a whole can be realized.

In practice, local vaporization can be achieved through a low pressure in conjunction with a high temperature. In the case of an electronic cigarette, the low pressure is achieved, for example, by the suction pressure when puffing on the cigarette during consumption, and so the pressure is regulated by the consumer. The temperatures in the liquid store required for vaporization are generated by a heating unit. Here, temperatures of more than 200° C. are generally reached in order to ensure rapid vaporization.

The heating output is usually provided by an electrical heating coil operated by means of a battery or rechargeable battery. The heating output required depends on the volume to be vaporized and the effectiveness of the heating. In order to avoid decomposition of the liquid due to excessively high temperatures, the heat transfer from the heating coil to the liquid should occur by noncontact radiation. To this end, the heating coil is attached as close as possible to the vaporization surface, but preferably without touching it. If, on the other hand, the coil touches the surface, the liquid will be often overheated and decomposed.

However, overheating of the surface can occur even in the case of heat transfer by contactless radiation. The overheating usually occurs locally on the surface of the vaporizer opposite the heating coil. This is the case when a large amount of vapor is required during operation and the liquid transfer to the surface of the vaporizer is not sufficiently rapid. Thus, the energy supply from the heating element cannot be used for vaporization, and the surface dries out and it can be heated locally to temperatures far above the vaporization temperature and/or the temperature stability of the liquid store is exceeded. Therefore, accurate temperature adjustment and/or control is essential. However, a disadvantage here is the resulting complex structure of the electronic cigarette, which is manifested, inter alia, in high production costs. Moreover, the temperature regulation may reduce vapor development and thus the maximum possible vapor intensity.

EP 2 764 783 A1 describes an electronic cigarette comprising a vaporizer having a porous liquid store composed of a sintered material. The heating element can be in the form of a heating coil or in the form of an electrically conductive coating, said coating being deposited only on parts of the lateral surfaces of the liquid store. Thus, localized vaporization also occurs here.

US 2011/0226236 A1 describes an inhaler in which the liquid store and the heating element are integrally connected to one another. Liquid store and heating element form a planar composite material. The liquid store, composed of an open-pored sintered body for example, acts as a wick and conducts the liquid to be vaporized to the heating element. The heating element is applied to one of the surfaces of the liquid store, for example in the form of a coating. Here too, localized vaporization thus occurs on the surface, and so there is also the risk of overheating.

In order to avoid this problem, vaporizer units are known from the prior art, in which the vaporization occurs not just on the surface of the liquid store, but over the entire volume thereof. The vapor develops not just locally on the surface, but throughout the volume of the liquid store. Thus, the vapor pressure within the liquid store is largely constant and capillary transport of the liquid to the surface of the liquid store is furthermore ensured. Accordingly, the vaporization rate is no longer minimized by capillary transport. A corresponding vaporizer requires an electrically conductive and porous material. When an electrical voltage is applied, the entire volume of the vaporizer heats up and vaporization takes place throughout the volume.

Corresponding vaporizers are described in US 2014/0238424 A1 and US 2014/0238423 A1. Here, liquid store and heating element are combined in one component, for example in the form of a porous body composed of metal or a metal mesh. However, a disadvantage here is that the ratio of pore size to electrical resistance cannot be easily adjusted in the porous bodies described. In addition, after the conductive coating has been applied, degradation of the coating can occur as a result of subsequent sintering.

The materials described in the prior art mentioned above are, however, not suitable, or only suitable to a limited extent, for producing composites having both a high, adjustable porosity and good electrical conductivities by means of a sintering process. In general, it is also difficult to provide ceramics with a continuous coating owing to their fine porosity and rough surface.

DE 10 2017 123 000 A1 therefore vaporizers comprising a sintered body composed of glass or glass-ceramic, the entire surface of which has a conductive coating. Thus, in contrast to sintered bodies which only have a corresponding coating on the outer surface, vaporization takes place not only on the outer surface but also inside the sintered body. Corresponding vaporizers are produced by first producing a porous sintered body composed of glass or glass-ceramic, which, in a subsequent step, is provided with a relatively thick conductive coating, for example in the form of an ITO coating. However, a disadvantage is that the production process becomes cost-intensive owing to the high material demand for conductive material such as ITO. Furthermore, the properties of the sintered body may be adversely altered as a result of the subsequent application of a thick coating. In particular, small pores in the sintered body can be closed by the coating and the active surface area of the sintered body can thus be reduced.

Moreover, when using glass as the main component of the sintered body, the problem of low dimensional stability of the sintered body or its precursor can occur during production. Thus, although the glasses used have good joining properties, the relatively low softening temperatures required therefor lead to low dimensional stability of the workpiece at high temperatures. This can lead to deformation or shrinkage of the workpiece during the sintering process, especially when producing sintered bodies having a high porosity, which is required for use as a vaporizer or liquid store. Besides poor shape fidelity between green body and sintered body, this can also have an adverse effect on the porosity of the sintered body. Therefore, in the known methods, priority is given to using pore formers which are only removed from the sintered body after completion of the sintering operation and thus stabilize the workpiece during sintering. The pore formers used are usually water-soluble salts having high temperature stability and a high melting point. However, a disadvantage of this method is that only a limited selection of pore formers is available. Moreover, an additional method step is required for washing out the pore formers.

### SUMMARY

It is therefore an object of the invention to provide a sintered body which is especially suitable for use as a vaporizer in electronic cigarettes and/or drug administration devices and/or thermally heated evaporators for fragrances and which does not have the disadvantages described above. It is a further object of the invention to provide a vaporizer comprising a sintered body. Thus, the aim of the invention is good heatability and simple adjustability of the electrical resistance and porosity of the liquid store. It is a further object of the invention to provide a method for producing a corresponding electrically conductive sintered body. Moreover, it is an object of the invention to allow the use of the sintered body in a vaporizer.

The sintered body according to the invention is especially suitable for use in a vaporizer unit. A vaporizer according to the invention comprises the electrically conductive sintered body.

The electrically conductive sintered body is in the form of a composite of at least two electrically conductive materials and at least one dielectric material. Here, the sintered body comprises at least one first electrically conductive material and at least one second electrically conductive material, wherein the first electrically conductive material has a lower electrical conductivity than the second electrically conductive material. Preferably, the electrical conductivity of the first electrically conductive material is less than 30 S/μm, in particular up to 10 S/μm. Furthermore, the second electrically conductive material preferably has an electrical conductivity of greater than 10 S/μm, particularly preferably greater than 30 S/μm. In general, the conductivity values mentioned here refer to the conductivity value at room temperature.

In particular, the at least one first conductive material forms a scaffold for the sintered body. Said scaffold serves to create a stable element, and this remains mechanically stable even at the sintering temperature.

According to a preferred embodiment, at least one of the electrically conductive materials used, i.e., the first or the second electrically conductive material, has a resistance with a positive temperature coefficient. Particularly preferably, both electrically conductive materials have such a positive temperature coefficient. This facilitates control of the electrical heating of the sintered body and supports rapid heating from room temperature.

Stored in the porous vaporizer by adsorptive interactions is a carrier liquid which, for example, can contain fragrances and flavorings and/or drugs, including active ingredients dissolved in suitable liquids, and/or nicotine. When an electrical voltage is applied, high temperatures are generated owing to the electrical conductivity of the vaporizer, and so the carrier liquid is vaporized and desorbed from the wetted surface of the vaporizer and the vapor can be inhaled by the user.

The sintered body has an open porosity in the range from 10% to 90%, preferably in the range from 50% to 75%, based on the volume of the sintered body. As a result, the sintered body has a large inner surface area for desorption with simultaneous high mechanical stability and allows good afterflow of the liquid to be vaporized or the medium to be vaporized.

Preferably, at least 90%, in particular at least 95%, of the total pore volume is present as open pores. Open porosity can be determined using measurement methods according to DIN EN ISO 1183 and DIN 66133. The sintered body preferably contains only a small proportion of closed pores. As a result, the sintered body has only a small dead volume, i.e., a volume which does not contribute to absorbing and delivering the liquid to be vaporized.

Preferably, the sintered body has a proportion of closed pores of less than 15% or even less than 10% of the total volume of the sintered body. To determine the proportion of closed pores, open porosity can be determined as described above.

Total porosity is calculated from the density of the body. The difference between total porosity and open porosity then yields the proportion of closed pores. According to one embodiment of the invention, the sintered body even has a proportion of closed pores of less than 5% of the total volume, the occurrence of which is process-dependent.

The dielectric material contained by the sintered body is one of the materials glass, ceramic, glass-ceramic, plastic or a combination of these materials.

Here, dielectric material and electrically conductive materials form the composite material of the sintered body. For the purposes of this disclosure, a dielectric or a dielectric material refers in particular to an electrically weakly conductive or electrically nonconductive substance in which the charge carriers present are not freely movable, or at least not freely movable at room temperature.

The proportion of dielectric material is at least 5% by volume, and according to one embodiment of the invention, the proportion of dielectric material in the composite material is in the range from 5% to 70% by volume, preferably in the range from 10% to 50% by volume. The total proportion of electrically conductive material in the composite material is at most 95% by volume. According to one embodiment of the invention, the total proportion of electrically conductive material in the composite material is from 30% to 95% by volume, preferably 50% to 90% by volume. Here, the proportions stated above are based on the composite material of the sintered body, i.e., the pore volume or the proportion by volume of the pores in the sintered body is not taken into account here.

According to one embodiment, the sintered body contains at least two different dielectric materials. In particular, the dielectric materials used have no appreciable electrical conductivity at room temperature.

In the sintered body according to the invention, the electrically conductive materials are connected to one another by the dielectric material. The electrical conductivity of the first electrically conductive material is preferably in the range of up to <30 S/μm, preferably in the range from 0.01 to 20 S/μm, particularly preferably in the range from 1 to 10 S/μm, and the electrical conductivity of the second electrically conductive material is preferably in the range of ≥10 S/μm, preferably >20 S/μm, most preferably >30 S/μm, in particular in the range of up to 70 S/μm. Here, the proportion of the first electrically conductive material in the sintered body is greater than the proportion of the second electrically conductive material. In connection with the above-described different electrical conductivities of the first and the second electrically conductive material, this allows a sintered body having an adjustable electrical conductivity within the range according to the invention with a simultaneously high mechanical strength. Thus, the first electrically conductive material allows in particular a high mechanical strength and shape fidelity of the sintered body. Owing to the relatively low electrical conductivity of the first electrically conductive material of at most 30 S/μm, the content of first electrically conductive material, in contrast to materials having high electrical conductivity, no longer has an exponential effect on the electrical conductivity of the sintered body, but an approximately linear effect. This allows easy adjustability of the electrical conductivity of the sintered body. Thus, sintered bodies having high contents of first electrically conductive material can be realized without excessively increasing the electrical conductivity of the sintered body. Besides good mechanical strength, what is also achieved especially in embodiments with relatively high contents of first electrically conductive material is a basic electrical conductivity with high homogeneity throughout the sintered body. Here, contents of first electrically conductive material in the composite of from 30% to 90% by volume, preferably 40% to 80% by volume and particularly preferably from 55% to 75% by volume have been found to be particularly advantageous. According to a further embodiment of the invention, the content of first electrically conductive material in the composite is from 30% to 80% by volume, preferably 40% to 70% by volume and particularly preferably 50% to 65% by volume. The electrically conductive materials can in particular be classified on the basis of the electrical conductivity thereof.

In particular, the classifications are as follows:

| | | Electrical |
|---|---|---|
| | | conductivity |
| Class | Example | [S/μm] |
| A | Ag, Cu, Au, Al | greater than 30 |
| B | W, Mo, Zn, Fe, Pt, Ni | 10 to 30 |
| C | Ti, Cr, steel, C, Mn, Si | less than 10 |

Especially because they are available commercially and cost-effectively at least to some extent, the materials of classes C and B are preferably usable for the formation of the metal scaffold and can be used to achieve or set a basic electrical conductivity of the sintered body.

Materials of class A are preferably usable for achieving, setting or fine-tuning a desired or required electrical conductivity of the sintered body.

The combining of materials from at least one class is preferably done according to the rule that the electrical conductivity of the first material is lower than the electrical conductivity of the at least one second material.

In an advantageous embodiment, class C and/or B are combined with class A, preferably class C with class A. According to one embodiment, the sintered body contains a material of class C and/or class B as first electrically conductive material and a material of class A as second electrically conductive material. It is also conceivable to combine class B with class C. In this embodiment, the sintered body contains a material of class C as first electrically conductive material and a material of class B as second electrically conductive material.

According to one embodiment of the invention, the sintered body comprises titanium, chromium, steel, manganese, nickel, copper, silicon or corresponding alloys, such as typical heat conductor alloy, in particular CuMnNi alloys (e.g., Constantan®) or FeCrAl alloys (e.g. Kanthal®), as first electrically conductive material. Mixtures or combinations of the abovementioned materials are possible, too.

The use of special steel as first electrically conductive material has been found to be particularly advantageous, in particular the use of stainless and/or scaling-resistant or heat-resistant special steel, for example of type 1.4828 or 1.4404. Here, special steel has not only an electrical conductivity advantageous for use as first electrically conductive material, but also a without chemical resistance. Furthermore, special steel is resistant to high temperatures and can also be used in medical settings. A further advantage is its relatively low production costs.

Proceeding from the basic conductivity of the sintered body, the desired electrical conductivity of said sintered body is set by the nature of the second electrically conductive material and the content thereof in the sintered body. According to one embodiment of the invention, the composite has a content of second electrically conductive material in the range from 5% to 50% by volume, preferably 10% to 30% by volume and particularly preferably 15% to 25% by volume.

What have been found to be advantageous as second electrically conductive material are, in particular, aluminum, copper and precious metals, in particular platinum, gold and silver, and also mixtures thereof and/or alloys thereof. A mixture of at least two of the abovementioned materials is possible, too. Besides high electrical conductivity, precious metals additionally offer the advantage that they are inert or at least largely inert to the constituents of the dielectric material even at high temperatures, i.e., in particular they are materials with little or no tendency to react with the dielectric material and/or undergo oxide formation or some other chemical change. Inertness is thus also an important criterion for the selection of other electrically conductive materials and/or their alloys and/or mixtures, other than the precious metals and/or their alloys and/or mixtures. This is particularly advantageous in embodiments in which glasses are used as dielectric material. It is particularly advantageous to use silver or gold or alloys with at least one of these metals as second electrically conductive material.

According to a particularly advantageous embodiment, the sintered body comprises special steel (class C) as first electrically conductive material and silver (class A) as second electrically conductive material.

According to one development of the invention, the total electrically conductive material present in the sintered body is first and second electrically conductive material. In other words, the electrically conductive material, apart from an optional coating, is formed only by the at least one first and at least one second electrically conductive material without a further conductive phase being present to a relatively great extent. In particular, the proportion of one or more further conductive phases or metals is less than 3% by volume. According to a preferred embodiment, the material of the electrically conductive particles has a resistance with a positive temperature coefficient. This facilitates control of the electrical heating of the sintered body and supports rapid heating from room temperature.

In an alternative or additional embodiment, there is also good controllability if the temperature coefficient of electrical resistance is close to zero, in particular less than 0.00025 K⁻¹. This is the case, for example, with some copper-nickel alloys, such as Constantan®. Constantan has a temperature coefficient of −0.000074 K⁻¹. Similarly, NiCr80 with a temperature coefficient of +0.00011 K⁻¹ can be used.

It has been found to be particularly advantageous to use electrically conductive materials, in particular metals, which have a temperature coefficient of electrical resistance of >−0.075 l/K, but preferably ≥−0.0001 l/K, particularly preferably ≥0.0001 l/K. According to an advantageous embodiment, the electrically conductive material has here a temperature coefficient of electrical resistance of <0.008 l/K.

The particular content of electrically conductive particles that is used, in particular those of the second electrically conductive material, is dependent here on the particular material of the electrically conductive particles, in particular on the electrical conductivity thereof and on the shape of the particles used.

According to one embodiment of the invention, the maximum distance between two adjacent electrically conductive particles is less than 30 μm or even less than 10 μm. This small distance between the electrically conductive particles means that the current flow can occur through electron tunneling. According to one development of this embodiment, the electrically conductive particles are at least partially spaced from one another. In this case, the electrically conductive particles are insulated from one another by the dielectric material and/or pores. What has been found to be particularly advantageous is an average distance between adjacent electrically conductive particles of less than 30 μm, preferably in the range of less than 10 μm.

The electrically conductive material is in particulate form, the particles of the first and the second electrically conductive material forming a homogeneous mixture. The dielectric material is the means by which the electrically conductive particles are held together. Here, the second electrically conductive particles are homogeneously distributed in the sintered body. The homogeneous distribution of the second electrically conductive particles in the composite ensures that the entire volume of the sintered body has a homogeneous conductivity in the range from 0.1 to 10⁵ S/m. According to one embodiment of the invention, the electrical conductivity of the sintered body is in the range from 10 to 10 000 S/m.

The electrical conductivity of the invention of the sintered body allows the use of the corresponding vaporizer in an electronic cigarette. Thus, the sintered body according to one development of the invention has an electrical resistance in the range from 0.05 ohms to 5 ohms, preferably 0.1 to 5 ohms. In this development, the vaporizer is operated with a voltage in the range from 1 to 12 V and/or with a heating output of at least 1 to 500 watts, in particular 1 to 300 watts, preferably 1 to 150 watts. Here, the vaporizer heats up as a result of the application of a current throughout its volume, with the result that the desorption of the liquid stored in the vaporizer begins.

In contrast, devices according to another development can also be operated at voltages of 110 V, 220 V/230 V or even 380 V. Here, electrical resistances of up to 3000 ohms and outputs of up to 1000 W or greater are advantageous. According to one embodiment of this development, the device is an inhaler for the medical setting.

Depending on the particular use of the vaporizer unit, it can have higher operating voltages, in particular operating voltages in the range from >12 V to 110 V, resistances of greater than 5 ohms and/or heating outputs of greater than 80 W. According to one embodiment of this development, the device is an inhaler for the medical setting. The vaporizer devices of this development can also be designed for vaporization in relatively large spaces, for example as a smoke machine.

The entire accessible surface of the sintered body consisting of composite material forms here the vaporization face. Owing to the electrical conductivity of the invention of the sintered body, the current flow occurs throughout the entire body volume of the sintered body. Accordingly, the liquid to be vaporized is vaporized on the entire surface of the sintered body. Thus, vapor formation occurs not only locally on the lateral surface of the sintered body, but also on the inner surface of the sintered body.

In contrast to vaporizers having a local heating device, for example a heating coil or an electrically conductive coating on the lateral surfaces of the vaporizer body, there is no need for capillary transport from the interior of the sintered body toward a local heating device, i.e., no need for capillary transport over relatively long distances, since what is heated in the case of the vaporizer according to the invention is the entire volume thereof. This prevents the vaporizer from running dry, and thus also prevents local overheating, in the case of an excessively low capillary effect. This has an advantageous effect on the service life of the vaporizer unit. Moreover, local overheating of the vaporizer can lead to decomposition processes of the liquid to be vaporized. Firstly, this can be problematic because, for example, the active ingredient content of a drug to be vaporized is thus reduced. Secondly, decomposition products are inhaled by the user, which can entail health risks. In the case of the vaporizer according to the invention, by contrast, this risk is significantly lower.

The proportion of dielectric material in the sintered body leads to good mechanical stability and strength of the sintered body. The use of a sintered body in the form of a composite, i.e., a sintered body in which dielectric material and electrically conductive particles are distributed homogeneously or at least largely homogeneously, offers the advantage, in contrast to sintered bodies given a subsequent coating, that properties of the sintered body, for example the pore size thereof or the proportion of open pores in the sintered body, are not adversely affected.

The electrical conductivity of the sintered body can be influenced not only by the electrical conductivity of the particular electrically conductive material used and the content thereof in the sintered body, but also by the particle size of the electrically conductive particles and by the particle shape or particle geometry. For instance, what has been found to be advantageous is especially the use of electrically conductive particles, especially for the second electrically conductive material, which deviate from a round particle shape, i.e., from substantially spherical particles. According to one embodiment, the electrically conductive particles therefore have a planar, platelet-shaped form and are also referred to as platelets. Alternatively or additionally, the composite comprises electrically conductive particles having a long-particle or elongated geometry. In particular, said particles have an acicular geometry. Mixtures of one or more of these particle shapes have been found to be particularly advantageous, too. In contrast to spherical particles for example, platelet-shaped or elongated particles can form a continuous scaffold of electrically conductive material within the sintered body even with relatively low degrees of filling, and so the corresponding sintered body has an electrical conductivity in the range according to the invention despite a relatively low degree of filling of the electrically conductive material. Accordingly, a required electrical conductivity of a sintered body can be achieved with elongated electrically conductive particles having a relatively low volume fraction than with spherical particles. Further ways of reducing this volume fraction, including with respect to elongated particles, often also associated with further reduced costs, can be achieved by platelet-shaped particles.

Furthermore, the use of planar, platelet-shaped or elongated electrically conductive particles is especially also advantageous when the degree of filling of the electrically conductive material in the sintered body is relatively low. Here, electrically conductive particles having the above-described geometries can form a network of electrically conductive material in the sintered body even with low degrees of filling, and so electrical conduction can be ensured and use as a heating element or in a vaporizer, for example, is made possible when a voltage or current flow is applied through the suitably sized sintered body.

According to one embodiment of the invention, the sintered body comprises electrically conductive particles having a platelet-shaped or elongated geometry. According to one development of the invention, the electrically conductive particles have a maximum thickness dₘₐₓ and a maximum length lₘₐₓ, where dₘₐₓ<lₘₐₓ. What have been found to be particularly advantageous are electrically conductive particles for which 2 dₘₐₓ<lₘₐₓ, preferably 3 dₘₐₓ≤lₘₐₓ, particularly preferably 7 dₘₐₓ<lₘₐₓ.

According to one development of the invention, the electrically conductive particles in the sintered body have a mean particle size (d₅₀) in the range from 0.1 μm to 1000 μm, preferably in the range from 1 to 200 μm, most preferably from 1 to 50 μm. According to one embodiment of the sintered body, the particle sizes, in particular the d₅₀ value of first and second conductive particles, differ. Preferably, the ratio of larger d₅₀ value to smaller d₅₀ value is at least 2:1, preferably at least 5:1. In specific embodiments, larger ratios can also be chosen, for example at least 7:1 or even at least 10:1. In order to ensure, inter alia, good miscibility of the particles before sintering, it is also advantageous if the ratio of the d₅₀ values does not become too large. According to another development, the ratio is therefore at most 500:1. In general, either the first conductive particles or the second conductive particles can have the larger particle sizes or d₅₀ values.

When using electrically conductive particles having a smaller particle size, in particular those of the second electrically conductive material, it is advantageous if the degree of filling of the electrically conductive particles in the corresponding sintered bodies is increased in order to achieve sufficient electrical conductivity. Thus, electrical conductivity is reduced by the use of very small electrically conductive particles. Excessively large electrically conductive particles, in particular those of the first electrically conductive material, can in turn greatly lower the electrical resistance in the sintered body in local regions, and so the electrical resistance of the sintered body is inhomogeneous. This in turn can lead to local overheating in the sintered body and to inhomogeneous vaporization. Here, this effect is all the more pronounced, the greater the electrical conductivity of the corresponding electrically conductive particles. Moreover, very large electrically conductive particles and the associated inhomogeneous structure of the sintered body can have an adverse effect on the mechanical strength thereof.

According to one embodiment of the invention, the pores have a mean pore size in the range from 1 μm to 1000 μm. Preferably, the mean pore size of the open pores of the sintered body is in the range from 50 to 800 μm, particularly preferably in the range from 100 to 600 μm. Appropriately sized pores here are advantageous because they are small enough to generate a sufficiently large capillary force and to thus ensure the supply of liquid to be vaporized, especially in the case of use as a liquid store in a vaporizer; at the same time, they are large enough to allow rapid delivery of the vapor. It is also conceivable to advantageously provide more than one pore size or more than one pore size range, for example a bimodal pore size distribution with large pores and small pores, in a sintered body. It has also become apparent that the proportion of electrically conductive particles, at a specified or required electrical conductivity of a sintered body, can be lower in the case of low porosity than in the case of sintered bodies of higher porosity. The particular use and the requirements thereof, as described above, for example transport of a liquid to be vaporized versus vaporization capacity, can thus be taken into account by suitable adjustments of material composition and porosity. Preferably, the dielectric material in the sintered body is thermally stable to temperatures of at least 300° C. or even at least 400° C. At the same time, the dielectric material has a softening temperature T_{g} below the melting temperature of the first electrically conductive material, preferably below the melting temperature of the first and the second electrically conductive material, in the sintered body.

According to one embodiment of the invention, the dielectric material of the sintered body comprises a glass. Here, according to one embodiment, the content of glass in the sintered body is at least 5% by volume. According to a further embodiment, just a small proportion of glass of less than 5% by volume can, however, also be provided, for instance in order to bind other particles, for example ceramic particles. The use of glass as dielectric material is advantageous with respect to processability in the production of the sintered body and with respect to temperature stability and mechanical strength. Here, what have been found to be particularly advantageous are glasses with or without a relatively low alkali metal content. Alkali metal-free glasses or glasses without an alkali metal content are understood to mean glasses without specific addition of alkali metals to the composition thereof. However, small proportions of alkali metal, introduced into the glass in the form of impurities for example, cannot be ruled out. A low alkali metal content, in particular a low sodium content, is advantageous here from a number of perspectives. For instance, glasses having a relatively low alkali metal content exhibit low alkali metal diffusion even at high temperatures, and so the glass properties do not change or virtually do not change even when the vaporizer is heated. The low alkali metal diffusion of the glasses is furthermore also advantageous when the sintered body is used as a vaporizer, since there is thus no interaction of such constituents, which may escape, with the electrically conductive material and/or an optionally present coating of the sintered body and/or with the liquid to be vaporized. The latter is especially relevant when using the optionally coated sintered body as a vaporizer in medical inhalers. What has been found to be particularly advantageous is a proportion of alkali metal in the glass of at most 15% by weight or even at most 6% by weight.

According to an advantageous embodiment of the invention, the vaporizer contains a glass as dielectric material. What has been found to be particularly advantageous is a borosilicate glass, in particular one comprising the following constituents:

| | |
|---|---|
| SiO₂ | 50% to 85% by weight |
| B₂O₃ | 1% to 30% by weight |
| Al₂O₃ | 1% to 30% by weight |
| ΣLi₂O + Na₂O + K₂O | 0% to 30% by weight |
| ΣMgO + CaO + BaO + SrO | 1% to 40% by weight. |

However, it is also possible to use other glasses as dielectric material. For instance, besides borosilicate glasses, bismuth glasses or zinc glasses have for example also been found to be suitable. The last-mentioned glasses or similar glasses with other oxides are understood to mean that they comprise corresponding oxidic components, i.e., for example Bi₂O₃ or ZnO, as a major constituent, for example to an extent of at least 50% by weight or even up to 80% by weight.

The selection of the particular dielectric material, in particular a glass, can also influence the thermal expansion behavior of the dielectric component. A low thermal expansion thereof when used as a vaporizer is advantageous with respect to resistance to temperature changes or in the case of exposure of the sintered body to temperature changes. This can occur, for example, when using the composite in an electronic cigarette owing to repeated heat cycles which are often quite short.

Similar to the electrically conductive materials, the inertness or chemical resistance of the glass is also relevant, for example as regards possible reactions of glass, or avoidance of possible reactions of glass, with electrically conductive material, especially also during the production process for a sintered body through thermal treatment, for example during the sintering operation. Furthermore, an inertness of the dielectric material in relation to the auxiliaries used in the production process, for example in relation to sintering aids or pore formers, is advantageous. When using the sintered body as, for example, a vaporizer or a component in a vaporizer, what is essential is a high chemical resistance or low reactivity of the glass to the substances to be vaporized, for example propylene glycol, glycerol, water and/or mixtures thereof, and/or additives therein. Preference is given to using glasses having a high chemical resistance, in particular glasses having a class 3 hydrolytic resistance, particularly preferably glasses having a class 1 or 2 hydrolytic resistance (measured in accordance with ISO 719). Furthermore, glasses having a low proportion of network modifiers and/or having a high proportion of network formers have been found to be advantageous in terms of their chemical resistance. According to one embodiment, the glass has a proportion of network formers of at least 50% by weight, preferably a proportion of network formers of at least 70% by weight. Network formers are understood to mean, in particular, glass components which contribute to the formation of oxygen bridges in the glass, for example SiO₂, B₂O₃ and Al₂O₃.

Alternatively, the dielectric materials used can also be crystallizable glasses or partially crystallized glasses, in particular glass-ceramics, provided that processing below the melting temperature of the first electrically conductive material used is possible. Therefore, when using ceramics as a dielectric material having usually high melting temperatures, especially if it is above those of the metals used, sintering-promoting substances, for example a glass, preferably an above-described glass, are added, so that a sintered body is sintered or sinterable by means of liquid phase sintering with formation of a liquid phase of precisely said glass.

According to one embodiment of the invention, the sintered body comprises a mixture of at least two different dielectric materials.

Here, it has been found to be particularly advantageous if at least one of the dielectric components is a glass. According to one embodiment, the proportion of glass is at least 5% by volume of the dielectric material. Depending on the particular materials used, this embodiment may be advantageous especially in the case of sintered bodies having a total content of dielectric material of less than 25% by volume or even less than 10% by volume.

Alternative dielectric components can be glass-ceramics, ceramics or plastics, provided that processing below the melting temperature of the electrically conductive material used is possible.

A glass-ceramic for the purposes of the present disclosure is understood here to mean the conversion product of a green glass, i.e., a crystallizable glass, as a result of heating to appropriate temperatures at which ceramization takes place. Here, the glass-ceramic has both a vitreous phase and crystallites.

In the case of embodiments in which the dielectric material contains ceramics, the usually high sintering temperature of the ceramics must be taken into account. Therefore, when using ceramics as a dielectric material, especially if the sintering temperature of the ceramic is above the melting temperature of the metals used, sintering-promoting substances are added, so that a sintered body is sintered or sinterable by means of liquid phase sintering with formation of a liquid phase of precisely this sintering-promoting substance. Sinter-promoting substances which have been found to be particularly advantageous are, in particular, glasses and particularly the above-described glasses.

According to one embodiment of the invention, the sintered body comprises a mixture of at least two different dielectric materials. Here, the dielectric component of the sintered body is a composite comprising the particular dielectric materials used. In particular, the composite can be a composite of glass and ceramic. In contrast to glass-ceramic, the composite is a composite material.

According to one embodiment, the proportion of ceramic is at least 50% by volume, preferably at least 75% by volume, most preferably at least 90% by volume, based on the intended volume fraction of the dielectric material.

One embodiment of the invention even envisages that the proportion of ceramic in the total dielectric material of the sintered body is at least 80% by volume, preferably at least 90% by volume and very particularly preferably at least 95% by volume. Sintered bodies, the dielectric material of which is completely or at least almost completely ceramic, are possible, too, without departing from the invention.

However, in the case of sintered bodies having altogether a rather small proportion of dielectric material, it may be advantageous with respect to processability in the sintering process and with respect to the mechanical stability of the sintered body if at least 50% by volume of the total dielectric material, in particular at least 25% by volume of the dielectric material, is a glass. This is especially advantageous in the case of sintered bodies having a total proportion of dielectric material of less than 25% by volume, in particular less than 15% by volume, in the sintered body.

Besides promoting sinterability, the glass component which is then substantially melted also makes a positive contribution to the coatability of such a sintered body with a ceramic component of the dielectric material. Here, it is possible for grain sizes of ceramic and glass to be coordinated with one another so as to avoid segregation of the powders or agglomeration of a powder on the basis of greatly differing grain sizes during production. Here, it has been found to be advantageous if the selected grain size of the glass is not larger than that of the ceramic component. Bimodal or multimodal distributions with regard to the grain size distributions of glass component and ceramic component are possible, too, and allow adaptation of the grain sizes of all materials to one another on a case-by-case basis. In the case, too, of use of glass-ceramics for production of a sintered body comprising a glass-ceramic, it may be advantageous with respect to the sinterability of the workpiece to add a volume fraction of glass or to replace a volume fraction of the glass-ceramic with a glass.

According to a further variant, further materials can be added to a mixture of electrically conductive and dielectric materials in order, for example, to influence the processing or production of a sintered body. These can be, for example, so-called sintering aids for modification of the sintering conditions, for example setting, in particular lowering, the processing temperature, and/or materials which allow modification of properties of the sintered body or by which they become adjustable. For instance, especially when using high-melting ceramics as a dielectric material, it is possible by adding a sintering-promoting agent, for example a glass, advantageously an above-described glass, to carry out sintering with formation of a liquid phase at temperatures at which the electrically conductive material does not melt. Furthermore, it is thus possible by adding auxiliaries to adjust the thermal conductivity with regard to thermal insulation versus heating output, heating rate or heating of surrounding components, for example in the case of an e-cigarette, or else the surface properties of the sintered body with regard to absorption, desorption and/or afterflow of media to be vaporized.

Moreover, the corresponding dielectric materials should in principle have sufficient chemical resistance and also resistance to water and the constituents of liquids to be vaporized, for example propylene glycol and glycerol, but also the metals. Suitable plastics are, for example, temperature-stable polymers such as polyetheretherketone (PEEK), polyetherketoneketone (PEKK) or polyamides (PA).

According to one embodiment of the invention, the vaporizer comprises mechanical electrical contacting, electrical contacting through an electrically conductive connector or an integral electrically conductive bond. Preferably, electrical contacting is achieved by a solder connection.

According to one variant of the invention, the sintered body additionally comprises an electrically conductive coating. Here, what has been found to be particularly advantageous is an electrically conductive coating which extends over the entire surface of the sintered body. Thus, the surfaces of the sintered body that are formed by the pore surfaces in the interior of the sintered body are also provided with the electrically conductive coating. This is particularly advantageous, since the coated sintered body thus also has homogeneous electrical conductivity. Suitable coating materials are, for example, indium tin oxide (ITO), aluminum-doped zinc oxide (AZO) or titanium nitride (TiN) or combinations thereof. The coating can also comprise one of the materials in combination with other coating constituents.

As a result of the additional coating, which can also be applied only partially or sectionally to a sintered body depending on the coating method, the electrical conductivity of the vaporizer can be modified without changing the composition of the sintered body. Thus, according to one embodiment, the electrical conductivity of the sintered body can be adapted or adjusted, in particular increased and/or homogenized, by the coating. This can be used, for example, to produce vaporizers having particularly high electrical conductivities, by coating sintered bodies with a relatively high content of electrically conductive material. This also makes it possible to set a required electrical conductivity based on specified basic conductivities of sintered bodies as composites of dielectric material and electrically conductive material by applying suitable layer thicknesses of the coating. Any fluctuations in the conductivity of the sintered body or the basic conductivity thereof can thus likewise be easily compensated for. Moreover, it is possible, especially through local and/or lateral structuring of the electrically conductive coating, to realize a composite having a locally adapted conductivity, for example through localization of the conductivity. Through lateral structuring of the coating on the sintered body, it is thus possible to obtain zones having different electrical conductivities. For example, the sintered body can be divided into local heating zones and/or storage zones. The specific setting of transport zones and transport routes can be achieved in this way, too.

Furthermore, it is also possible by means of a coating to influence the surface properties, for example the surface activity or surface energy, of the sintered body or vaporizer, for example in order to alter or adjust the absorption, transport and delivery or vaporization of a liquid. In addition, the inertness of the sintered body can be further improved by passivation, so to speak, thereof by a coating, i.e., in order, for example, to protect against corrosion, degradation or aging due to reaction with air or with liquid to be vaporized, especially during operation. Thermomechanical properties of the sintered body can also be adapted, improved or adjusted, for example mechanical strength and/or thermal conductivity. In this case, a coating can address one or more of these properties.

Because the sintered body already has an electrical conductivity owing to the content of first and second electrically conductive material, only relatively low layer thicknesses are necessary compared to a coating of sintered bodies which do not contain an electrically conductive material. In comparison with a sintered body composed of a purely dielectric material, it is possible in the case of the sintered body according to the invention to reduce, in line with its basic electrical conductivity, the amount of necessary coating material, for example by up to 90%, in order to achieve comparable electrical conductivities.

Preferably, the average layer thickness of the electrically conductive coating is less than 10 μm or even less than 1 μm, as far as a few nanometers or a few 10 nm. The necessary or possible layer thickness is substantially by its nature and method of production of the coating. According to one embodiment, the coating is achieved with ITO or TiN. Here, ITO coatings have an electrical conductivity in the range from a few 10⁴ S/m to a few 10⁶ S/m, and that of a TiN coating ranges from a few S/m to a few 10³ S/m. The low layer thicknesses of the coating mean that, firstly, only a small amount of coating material is required. At the same time, the risk of smaller pores being closed by the coating and thus no longer being available as vaporization volume is significantly reduced. The necessary or sufficient layer thickness depends on the electrical conductivity of the coating material. Also, the layer thickness which is achievable or to be achieved depends on the methods of coating, for example by means of liquid deposition or vapor deposition, or electroplating. Thus, such methods are used for preferably dense and homogeneous application of layers to a sintered body in order to set the required electrical conductivity thereof and the required heating behavior thereof during operation, for example in a uniform manner or else in a localized manner in the volume of the sintered body.

The vaporizers according to the invention are especially suitable for use as a component in an electronic cigarette, a medical inhaler, a fragrance dispenser or a room humidifier. Here, for example, the vaporizer can also be used for indirect vaporization of liquids or solids, for example waxes or resins. Thus, according to one development of the invention, air or gas flows through the sintered body and it is heated. One possible use of this development is in medical inhalers. A radiant heater is another possible use.

A further aspect of the invention is that of providing a method for producing a vaporizer. Here, the method according to the invention comprises at least the following method steps a) to e): a) providing a first electrically conductive material, a second electrically conductive material and a dielectric material in powder form, b) mixing the powders provided in step a) with a pore former, c) producing a green body from the powder mixture provided in step b) by pressing, casting or extrusion, d) heating the green body provided in step c) to a temperature T_{burnout} and e) sintering the green body produced in step c) at a sintering temperature Tₛᵢₙₜₑᵣ.

Wherein especially in the case of plastics as dielectric material, steps c) to e) can also take place in parallel/simultaneously or sequentially in a unit, for example an extruder or in injection molding, optionally also comprising step b). In principle, such methods are also applicable to the other dielectric materials, but frequently complex and less easy to control. The term “sintering” is also understood here to mean a process step leading to solidification of such a body.

Here, the proportion of total electrically conductive material in the total materials provided in step a) is at most 95% by volume. According to a preferred embodiment, the proportion of electrically conductive material is in the range from 30% to 90% by volume, preferably in the range from 40% to 80% by volume. In step a), glasses, crystallizable glasses or glass-ceramics or ceramics or plastics or mixtures thereof in powder form are provided as dielectric material. According to one embodiment of the invention, the proportion of dielectric material in the materials provided in step a) is 5% to 70% by volume, preferably 10% to 50% by volume. Here, the dielectric material preferably has a lower softening or melting point than the electrically conductive material. According to a preferred embodiment, the dielectric material contained by the sintered body is glass, crystallizable glass or at least partially crystallized glass, the Tⱼₒᵢₙ joining temperature of which is below the melting temperature Tₘₚ of the first electrically conductive material, preferably below the melting temperature of all electrically conductive materials in the sintered body. Here, “joining temperature Tⱼₒᵢₙ” is understood to mean the temperature range in which the viscosity of the glass is in the range between 10⁴ and 10⁸ dPas. Preferably, the joining temperature Tⱼₒᵢₙ is at least 10° C., preferably at least 50° C. below the melting temperature of the first electrically conductive material and/or the second electrically conductive material.

According to a preferred embodiment, the proportion of dielectric material is in the range from 5% to 70% by volume, preferably in the range from 10% to 60% by volume and particularly preferably in the range from 15% to 40% by volume. In step a), glass, glass-ceramic, ceramics or mixtures thereof or plastics in powder form are provided as dielectric material.

In step b), the powder provided in step a) is admixed with at least one pore former and a homogeneous mixture is produced. The proportion of pore former in the mixture provided in step b) is preferably 40% to 80% by volume, preferably 50% to 75% by volume. From the mixture provided in step b), a green body is produced in a subsequent step c). This can be done, for example, by pressing or extrusion processes or by a casting process. In one embodiment of the invention, a slip is produced from the mixture provided in step b) and subsequently cast.

Here, the pore former has a decomposition temperature T_{decomposition} and/or a vaporization temperature T_{vaporization} which is below the in sintering temperature Tₛᵢₙₜₑᵣ in step d) and/or below the joining temperature Tⱼₒᵢₙ of the dielectric material. This ensures that the pore former is burned out in step d) before the sintering process in step e). This is advantageous because gaseous substances therefore do not escape during the sintering process and swelling of the sintered body is therefore avoided. According to one embodiment, the pore former has a decomposition temperature T_{decomposition} and/or a vaporization temperature T_{vaporization} which is at least 10° C., preferably at least 50° C. and particularly preferably at least 100° C. below the sintering temperature Tₛᵢₙₜₑᵣ and/or is at least 10° C., preferably at least 50° C. lower than the joining temperature Tⱼₒᵢₙ of the dielectric material.

According to one embodiment, an organic material, for example one based on polysaccharides, is used as pore former. Also possible is the use of inorganic salts, provided that the decomposition temperature and/or vaporization temperature thereof is below the joining temperature of the dielectric glass. In step e), the green body is sintered. Here, the sintering temperature corresponds to at least the softening temperature of the dielectric material, so that the dielectric material forms a coherent matrix as a result of the sintering process. However, at the same time, the sintering temperature is lower than the melting temperature of the electrically conductive material, so that the particle structure of the electrically conductive material is at least largely retained.

It has been found that a mixture or combination of dielectric and first electrically conductive materials in which the dielectric material can be softened or processed at a temperature which is at least 10° C. or even at least 100° C. below the melting point of the first electrically conductive material is particularly advantageous. As a result, what can take place in step e) is sintering at a temperature which makes a sintered body of high mechanical strength possible. Since the melting point Tₘₑₗₜ of the first electrically conductive material is both above burnout temperature T_{burnout} in step d) and above the joining temperature Tⱼₒᵢₙ of the dielectric material, the green body or the workpiece has a high dimensional stability throughout the production process, even after removal of the pore former. In particular, the melting point Tₘₑₗₜ of the first electrically conductive material is above the sintering temperature Tₛᵢₙₜₑᵣ in step e). Therefore, besides providing a basic electrical conductivity of the sintered body, the first electrically conductive material has the function of a shape stabilizer during the production process and thus allows the production of dimensionally stable, porous sintered bodies. In contrast to production methods using temperature-stable, soluble pore formers, it is possible in the method according to the invention, owing to the burnout in step c), to dispense with a washing process after the sintering operation for removal of the pore former.

Moreover, the comparatively high melting point of the first electrically conductive material ensures that the dimensional stability of the electrically conductive particles in the sintered body and thus also the electrical conductivity of the sintered body is not impaired by the sintering process. Preferably, the melting point of the second electrically conductive material is therefore also above the sintering temperature Tₛᵢₙₜₑᵣ in step e). According to one embodiment of the invention, the sintering of the green body is done at a sintering temperature in the range from 350° C. to 1000° C. in step e).

The sintered bodies produced by means of the method according to the invention have a high mechanical stability, and so postprocessing of the sintered body, for example for surface treatment or shaping, is possible. According to one development of the invention, the sintered body is ground, drilled, polished, milled and/or turned in a step f) downstream of step e).

Moreover, electrical contacting of the sintered body can be achieved in a step g) downstream of steps e) and/or f) of the sintered bodies. Here, what has been found to be particularly advantageous is contacting by applying an electrically conductive paste.

According to one embodiment, the dielectric material provided in step a) has a thermal stability to temperatures of at least 300° C. or even at least 400° C. According to one development of the invention, a glass is provided as dielectric material in step a). According to one embodiment of the invention, the glass provided in step a) has a transformation temperature T_{g} in the range of greater than 300° C., in particular in the range from 500° C. to 800° C. As a result, sintering can be carried out in step d) at sintering temperatures which ensure the dimensional stability of the electrically conductive particles. However, at the same time, the transformation temperature of the glass is distinctly above the operating temperature of the vaporizer.

According to one embodiment of the invention, a glass having an alkali metal content<15% by weight or even <6% by weight or even an alkali metal-free glass is provided in step a). Corresponding glasses exhibit a high mechanical strength, exhibit good chemical and thermal resistance, and do not react with, or hardly react with, the electrically conductive materials even at high temperatures. Preferably, a borosilicate glass is provided as dielectric material in step a).

It has been found to be particularly advantageous if the electrically conductive particles provided in step a) have a mean particle size (d₅₀) in the range from 0.1 to 1000 μm, preferably in the range from 1 to 50 μm.

Alternatively or additionally, the particles of the dielectric material provided in step a) have a mean particle size (d₅₀) in the range from 1 to 50 μm. In particular, the mean particle size (d₅₀) of the dielectric material is less than 30 μm. Corresponding particle sizes of the dielectric material lead to sintered bodies in which the maximum distance between adjacent electrically conductive particles is less than 30 μm or even less than 10 μm. This ensures current conduction in the corresponding sintered body even with low contents of electrically conductive material.

In step b), a particularly homogeneous mixture can also be obtained by coordinating the grain sizes of the powders of dielectric material and electrically conductive material with one another so as to avoid segregation of the powders or agglomeration of a powder on the basis of greatly differing grain sizes. A homogeneous mixture in step b) in turn has an advantageous effect on the homogeneity of the composite and thus also on the homogeneity of the electrical conductivity. Furthermore, excessively small grain sizes of the powders or of a powder should be avoided as far as possible, even if they are matched to one another with respect to grain sizes, in order to minimize unnecessary dust generation during processing thereof.

In step a), materials having an electrical conductivity of at most 30 S/μm, preferably titanium, chromium, steel, manganese, silicon or corresponding alloys, are used as first electrically conductive materials. Also possible are combinations of the abovementioned materials. Preferably, materials having an electrical conductivity in the range from >20 to 70 S/μm, in particular gold particles, silver particles and/or platinum particles, are provided as second electrically conductive. Here, these precious metals in particular have not only high electrical conductivities, but also high chemical resistance and/or high melting points.

According to one development of the invention, the particles of the electrically conductive material provided in step a), in particular those of the second electrically conductive material, have a platelet-shaped geometry, preferably a platelet-shaped geometry having a maximum thickness dₘₐₓ and a maximum length lₘₐₓ where dₘₐₓ<lₘₐₓ. Corresponding geometries are especially suitable for use in sintered bodies having a low proportion of electrically conductive materials, i.e., in sintered bodies in which a current flow is realized by electron tunneling currents to a large extent. Here, what have been found to be advantageous are especially platelet-shaped particles, the maximum length of which is at least twice the maximum width. According to a preferred embodiment, the ratio of maximum thickness to maximum length is from 1:2 to 1:7.

According to one development of the invention, an electrically conductive coating, in particular a coating, particularly preferably an oxidic ITO or AZO or nitridic, in particular TiN-containing, or metallic coating, is applied to the sintered body in a step h) downstream of step e) and/or step f). Here, according to a preferred embodiment, the coating is applied to the surface of the sintered body by means of a sol-gel process or a CVD process. It is also conceivable, especially since the sintered body already has at least one basic conductivity, to also consider coating materials applicable or processable by electroplating, for example gold, silver or copper and/or combinations thereof, for example as a sequence of coats.

### DETAILED DESCRIPTION

The invention will be described in greater detail below on the basis of exemplary embodiments and figures, where:

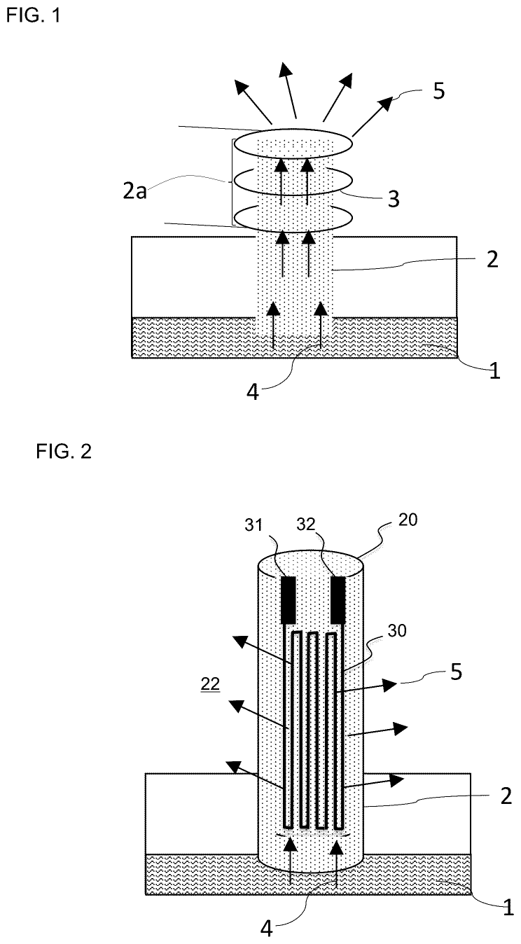

FIG. 1 shows a schematic representation of a conventional vaporizer,

FIG. 2 shows a schematic representation of a sintered body having electrical contacting on the lateral surfaces of the sintered body,

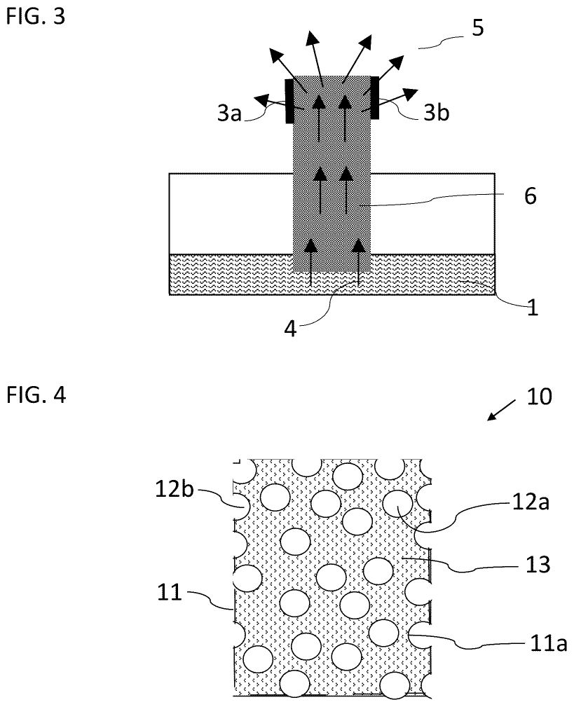

FIG. 3 shows a schematic representation of one embodiment of a vaporizer according to the invention,

FIG. 4 shows a schematic representation of one embodiment of a sintered body according to the invention in cross section,

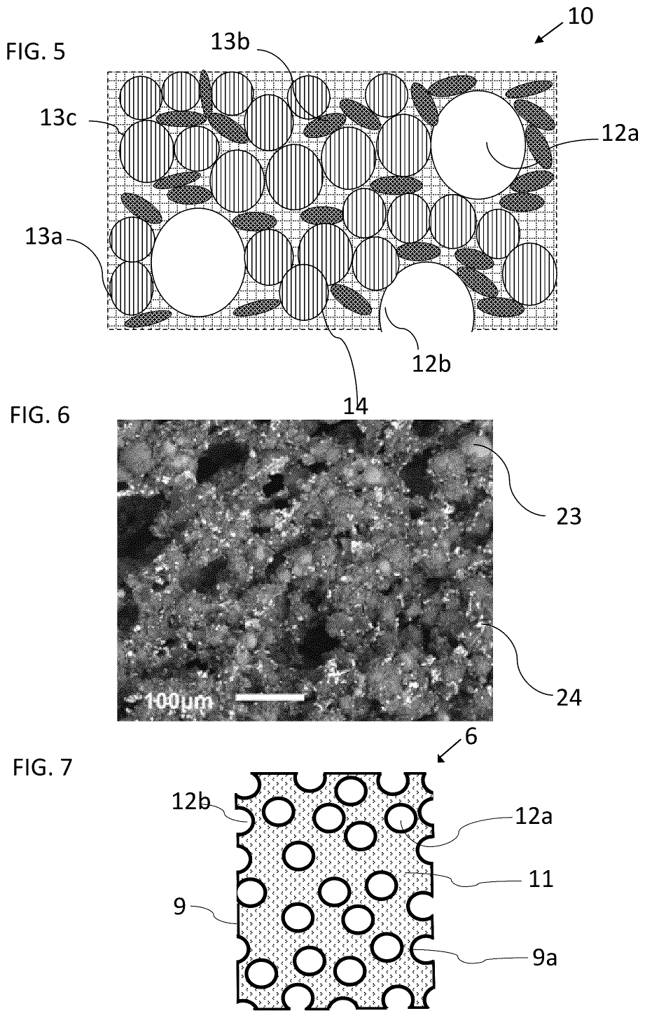

FIG. 5 shows an enlarged detail of the cross section shown in FIG. 4 and

FIG. 6 shows an SEM image of one exemplary embodiment and

FIG. 7 shows a schematic representation of a further exemplary embodiment with an additional electrically conductive coating on the sintered body.

### DETAILED DESCRIPTION

FIG. 1 shows an example of a conventional vaporizer comprising a porous sintered body 2 as a liquid store. Owing to the capillary forces of the porous sintered body 2, the liquid 1 to be vaporized is absorbed by the porous sintered body 2 and further transported in all directions of the sintered body 2. The capillary forces are symbolized by the arrows 4. In the upper section of the sintered body 2, a heating coil 3 is positioned in such a way that the corresponding section 2a of the sintered body 2 is heated by thermal radiation. The heating coil 3 is therefore brought very close to the lateral surfaces of the sintered body 2 and should not touch the lateral surfaces if possible. However, in practice, direct contact between heating wire and lateral surface is often unavoidable.

What takes place in the heating region 2a is the vaporization of the liquid 1. This is represented by the arrows 5. The vaporization rate depends on the temperature and the ambient pressure. The higher the temperature and the lower the pressure, the faster the vaporization of the liquid in the heating region 2a.

Since the vaporization of the liquid 1 takes place only locally on the lateral surfaces of the heating region 2a of the sintered body, the heating of this local region must be done with relatively high heating outputs in order to achieve rapid vaporization within 1 to 2 seconds. Therefore, high temperatures of greater than 200° C. must be applied. However, high heating outputs, especially in a localized region, can lead to local overheating and thus possibly to decomposition of the liquid 1 to be vaporized and of the material of the liquid store or wick.

Furthermore, high heating outputs can also lead to excessively rapid vaporization, with the result that further liquid 1 for vaporization cannot be provided quickly enough by the capillary forces. This likewise leads to overheating of the lateral surfaces of the sintered body in the heating region 2a. Therefore, what can be installed is a unit, for example a voltage, power and/or temperature-adjustment control unit (not depicted here), which, however, is at the expense of battery life and limits the maximum vaporization rate.

Therefore, the disadvantages of the vaporizer depicted in FIG. 1 and known from the prior art are the local heating method and the associated ineffective heat transfer, the complex and expensive control unit, and the risk of overheating and decomposition of the liquid to be vaporized and of the store/wick material.

FIG. 2 shows a vaporizer unit known from the prior art, in which the heating element 30 is arranged directly on the sintered body 20. In particular, the heating element 30 is fixedly connected to the sintered body 20. Such a connection can be achieved in particular by the heating element 30 being in the form of a film resistor. To this end, what is applied to the sintered body 20 is a ladder-structured electrically conductive coating in the manner of a film resistor. A coating applied directly to the sintered body 20 as a heating element 30 is, inter alia, advantageous for achieving good thermal contact, which allows rapid heating. However, the vaporizer unit shown in FIG. 2 also has only a localized vaporization surface, and so there is also the risk here of overheating of the surface.

FIG. 3 schematically shows the structure of a vaporizer comprising a sintered body 6 according to the invention. Like the porous sintered body 2 in FIG. 1 and FIG. 2, it is dipped into the liquid 1 to be vaporized. As a result of capillary forces (represented by the arrows 4), the liquid to be vaporized is transported into the entire volume of the sintered body 6. Thus, when an electrical voltage is applied between the contacts 3a and 3b, the sintered body 6 is heated in the entire volume region between the contacts 3a and 3b with a large surface area. Thus, in contrast to the vaporizer shown in FIG. 2, the liquid 1 is formed not just on the lateral surfaces of the sintered body, but in the entire volume region between the electrical contacts of the sintered body 6. Capillary transport to the lateral surfaces or heated surfaces or elements of the sintered body 6 is therefore not necessary. Moreover, there is less risk of local overheating. Since volume vaporization proceeds substantially more efficiently than vaporization by means of a heating coil in a localized heating region, vaporization can occur at substantially lower temperatures and at a lower heating output. A lower electrical power requirement is advantageous in that it is thus possible to increase the usage time per battery charge or to install smaller rechargeable batteries or smaller batteries.

FIG. 4 shows a schematic representation of a cross section through a sintered body 10 as one exemplary embodiment of the invention. Here, the sintered body 10 comprises a composite material 11 and, distributed therein, pores 12a, 12b. The composite material 11 has an electrical conductivity in the range from 0.1 to 10⁵ S/m. If a voltage is applied to the sintered body 10, current flows through the entire volume of the sintered body 10 and said volume is thus heated. FIG. 5 depicts an enlarged detail of the sintered body 10. The composite material 11 contains the first electrically conductive material 13a as a main constituent and contains electrically conductive particles of the second electrically conductive material 13b that are distributed, preferably homogeneously, between or on the first electrically conductive material 13a. Here, the electrically conductive particles 13a and 13b are held together by the dielectric material 13c. In the embodiment shown in FIG. 5, the electrically conductive particles 13a and 13b have a platelet-shaped geometry.

As described above, the heating of the sintered body 10 can be achieved by a current flow. Accordingly, a heating device in the form of a power source can be provided for this purpose. However, in general, without restriction to specific exemplary embodiments, induction heating is also possible. Accordingly, what is provided for this purpose in one embodiment is an induction heater configured to generate an induction field. For induction heating, the sintered body 10 is designed to absorb energy from the induction field and to heat up as a result. In general, induction heating is particularly easily realizable if the sintered body comprises an electrically conductive material that is ferromagnetic. Preferably, a ferromagnetic special steel as a first conductive material is provided for this purpose. Electrically conductive materials selected in this way thus also open up the possibility of carrying out the sintering process by means of induction heating. Also conceivable is heating in the sintering process by means of microwaves or capacitive technology.

Here, a corresponding sintered body 6 as Example 1 having an electrical conductivity of approx. 1 S/m and a porosity of approx. 55% by volume can be obtained in step a) by providing a mixture of 25% by volume of glass with 65% by volume of special steel 1.4404 (d50 of 50-150 μm) and 10% by volume of silver (d50 of 1-10 μm). In step b), a pore former, preferably an organic pore former, is added, followed by the production of a green body. It is subsequently heated by thermal treatment in a regular furnace atmosphere to a temperature approximately corresponding to the softening temperature of the glass used, and sintered to form the sintered body 6.

In a second exemplary embodiment, the sintered body has a porosity of 55% by volume. Here, the composite material contains 23% by volume of borosilicate glass (FIOLAX®) as dielectric material, 60% by volume of special steel 1.4404 as first electrically conductive material and 17% by volume of silver as second electrically conductive material. Here, the particles of the electrically conductive materials have a mean grain size d50 in the range from 20 to 60 μm. The electrical conductivity of the sintered body is 2000 S/m.

The electrical conductivity is determined by resistance measurement on, for example, test specimens of approx. 5 to 10 mm in diameter and 5 to 10 mm in height and conversion of the resistance value into electrical conductivity, with manual or mechanical arrangement or attachment of the measurement tips on/to the opposing diameters without further aids (e.g., conductive paste or soldering of contacts).

According to another development, the dielectric material, for instance according to Examples 1 and 2, is modified such that the dielectric component of the sintered body contains both glass and ceramic. According to one exemplary embodiment, the proportion of ceramic in the dielectric material is 85% by volume and the proportion of glass in the dielectric material is 15% by volume. Here, electrical conductivities in the range from 1 to 10 S/m can likewise be obtained. The inventors suspect that, although the nature of the dielectric material used influences the mechanical properties, it has only a very slight influence on the electrical conductivity of the sintered body. This also applies to sintered bodies, the dielectric component of which contains a mixture of glass-ceramic with one of the constituents glass and ceramic or both of said constituents. A glass-ceramic component can also be formed by initially introducing a crystallizable glass in the green body, which glass ceramizes during sintering at an appropriate temperature for ceramization of said glass and is then present as a glass-ceramic. Below such a temperature, a crystallizable glass remains in the vitreous state.

FIG. 6 shows an SEM image of a cross section through a sintered body according to the invention as a further exemplary embodiment. The scaffold-forming metal used in this example was special steel. The special steel particles are substantially round, in particular oval to spherical. Some of these round particles 23 can be seen as round, light-gray elements in the SEM image. In the SEM image, the glass exhibits a similar contrast to the special steel, and so differentiation thereof in the image is hardly possible. Appearing as very light regions are the sintered particles 24 of the second electrically conductive material, which are silver particles here. The pores can be seen in the image as black regions. In general, the mean grain sizes of the first and the second conductive material can differ. As can also be seen in the example in FIG. 6, the mean grain size of the second electrically conductive material (silver particles in the example) is preferably smaller than the mean grain size of the first electrically conductive material (special steel particles in the example).

FIG. 7 shows the structure of a coated sintered body 6 having open porosity on the basis of a schematic cross section through a further exemplary embodiment. The coated sintered body 1 comprises a porous composite material 11 composed of dielectric material, first electrically conductive material and second electrically conductive material having open pores 12a, 12b. By means of their pore surface, one portion of the open pores 12b forms the lateral surfaces of the sintered body, whereas another portion of the pores 12a forms the interior of the sintered body. All surfaces of the sintered body comprise an electrically conductive coating 9a, for example in the form of an ITO coating. If a voltage is applied to the sintered body, the current flows through the entire volume of the sintered body.

Here, a correspondingly coated sintered body 6 as Example 8 can be obtained by first producing a sintered body having a relatively low electrical conductivity in the range from 0.1 to 100 S/m. In order to obtain the desired, relatively high electrical conductivity, for example in the range from 100 to 600 S/m, the sintered body is subsequently provided with an electrically conductive coating, for example an ITO-containing or AZO-containing coating. Here, the basic electrical conductivity of the sintered body means that 50% less coating material is required (compared to a sintered body without electrically conductive material). Furthermore, the coating process is also less time-consuming. Thus, the process time required for the coating process can be reduced by up to 70%.

### LIST OF REFERENCE SIGNS

1 Carrier liquid
2 Sintered body
2a Heating zone
3, 30 Heating element
3a, 3b Contacts
4 Capillary forces
5 Vapor
6 Sintered body
8a, 8b Pores
9, 9a Electrically conductive coating
10 Electrically conductive sintered body
11 Composite material
12a, 12b Pore
13a First electrically conductive material
13b Electrically conductive particles of the second electrically conductive material
13c Dielectric material
14 Distance between adjacent electrically conductive particles
20 Sintered body
22 Vaporizer
23 Round particle
24 Particle of the second electrically conductive material
31, 32 Contacting

What is claimed is:

1. A vaporizer comprising:
a porous sintered body formed by a composite of a first electrically conductive material, a second electrically conductive material, and a dielectric material,
wherein the porous sintered body has an open porosity in the range from 10% to 90% and an electrical conductivity in a range from 0.1 to 10⁵ S/m,
wherein the dielectric material is selected from a group consisting of glass, crystallizable glass, glass-ceramic, ceramic, plastic and combinations thereof,
wherein the first electrically conductive material has a lower electrical conductivity than the second electrically conductive material, and
wherein the composite has a proportion of the dielectric material from 5% to 70% by volume, the first electrically conductive material from 10% to 90% by volume, and the second electrically conductive material from 5% to 50% by volume.

2. The vaporizer of claim 1, wherein the proportion is selected from a group consisting of: the first electrically conductive material from 40% to 90% by volume, the first electrically conductive material from 55% to 75% by volume, the second electrically conductive material from 5% to 50% by volume, the second electrically conductive material from 15% to 30% by volume, a total of the first and second electrically conductive materials from 30% to 95% by volume, and a total of the first and second electrically conductive materials from 40% to 90% by volume.

3. The vaporizer of claim 1, wherein the composite comprises a feature selected from a group consisting of: the first electrically conductive material having an electrical conductivity of up to 30 S/μm, the first electrically conductive material having an electrical conductivity of up to 20 S/μm, the first electrically conductive material having an electrical conductivity from 0.001 to 10 S/μm, the second electrically conductive material having an electrical conductivity of greater than 10 S/μm, the second electrically conductive material having an electrical conductivity of greater than 20 S/μm, the second electrically conductive material having an electrical conductivity of greater than 30 S/μm, the second electrically conductive material having an electrical conductivity of up to 70 S/μm, the first electrically conductive material having a resistance with a positive temperature coefficient, the second electrically conductive material having a resistance with a positive temperature coefficient, the first and second electrically conductive materials having a resistance with a positive temperature coefficient, the first electrically conductive material having a temperature coefficient of resistance of at least −0.0001 l/K, the second electrically conductive material having a temperature coefficient of resistance of at least −0.0001 l/K, the first electrically conductive material having a temperature coefficient of resistance of less than 0.008 l/K, the second electrically conductive material having a temperature coefficient of resistance of less than 0.008 l/K, the first electrically conductive material having a temperature coefficient of resistance of at least −0.0001 l/K and less than 0.008 l/K, and the second electrically conductive material having a temperature coefficient of resistance of at least −0.0001 l/K and less than 0.008 l/K.

4. The vaporizer of claim 1, further comprising an electrical resistance in a range from 0.05 to 5 ohms.

5. The vaporizer of claim 4, wherein the electrical resistance is from 0.1 to 5 ohms.

6. The vaporizer of claim 4, wherein the porous sintered body comprises the electrical resistance.

7. The vaporizer of claim 1, further comprising a voltage in the range from 1 to 12 V and/or a heating output of from 1 to 500 W.

8. The vaporizer of claim 1, wherein the first and/or second electrically conductive material comprise a material selected from a group consisting of: titanium, chromium, steel, iron, molybdenum, tungsten, manganese, nickel, copper, silicon, stainless steel, aluminium, platinum, gold, silver, and any mixture or alloys thereof.

9. The vaporizer of claim 1, wherein the porous sintered body further comprises an electrically conductive coating.

10. The vaporizer of claim 1, wherein the first and/or the second electrically conductive materials comprise particles having a feature selected from a group consisting of: a particle size d₅₀ in a range from 0.1 μm to 1000 μm, a particle size d₅₀ in a range from 1 to 300 μm, a particle size d₅₀ in a range from 0 1 to 150 μm, a shape that is platelet-shape, a maximum length that is larger than a maximum thickness, a maximum length that is larger than twice a maximum thickness, and a maximum length that is larger than seven times a maximum thickness.

11. The vaporizer of claim 1, wherein the open porosity comprises pores having a mean pore size in a range from 1 μm to 5000 μm.

12. The vaporizer of claim 1, wherein the dielectric material comprises glass having a feature selected from a group consisting of: an alkali metal content≤15% by weight, having an alkali metal content≤6% by weight, a proportion of network formers of at least 50% by weight, a proportion of network formers of at least 70% by weight, a transformation temperature in a range from 300° C. to 900° C., a transformation temperature in a range from 500° C. to 800° C., a class 3 hydrolytic resistance measured in accordance with ISO 719, a class 2 hydrolytic resistance measured in accordance with ISO 719, and a class 1 hydrolytic resistance measured in accordance with ISO 719.

13. The vaporizer of claim 1, wherein the dielectric material comprises glass comprising:

| | |
|---|---|
| SiO₂ | 50% to 85% by weight, |
| B₂O₃ | 1% to 30% by weight, |
| Al₂O₃ | 1% to 30% by weight, |
| ΣNa₂O + K₂O | 1% to 30% by weight, and |
| ΣMgO + CaO + BaO + SrO | 1% to 40% by weight. |

14. The vaporizer of claim 1, wherein the vaporizer is configured as a component for a use selected from a group consisting of an electronic cigarette, a medical inhaler, a fragrance dispenser, a room humidifier, a disinfection device, and a gas heating device.

15. A porous sintered body, comprising
a porous sintered body formed by a composite of a first electrically conductive material, a second electrically conductive material, and a dielectric material,
wherein the porous sintered body has an open porosity in the range from 10% to 90% and an electrical conductivity in a range from 0.1 to 10⁵ S/m,
wherein the dielectric material is selected from a group consisting of glass, crystallizable glass, glass-ceramic, ceramic, and combinations thereof,
wherein the first electrically conductive material has a lower electrical conductivity than the second electrically conductive material, and
wherein the composite has a proportion of the dielectric material from 5% to 70% by volume, the first electrically conductive material from 10% to 90% by volume, and the second electrically conductive material from 5% to 50% by volume.

16. A method for producing a vaporizer, comprising:
a) providing a first electrically conductive material, a second electrically conductive material, and a dielectric material in powder form;
b) mixing the first electrically conductive material, the second electrically conductive material, and the dielectric material in powder form provided in step a) with at least one pore former to produce a powder mixture;
c) producing a green body from the powder mixture provided in step b) by pressing, casting or extrusion; and
d) sintering the green body produced in step c) at a sintering temperature.

17. The method of claim 16, wherein the providing in step a) further comprises:
providing a proportion of the dielectric material from 5% to 70% by volume;
providing a proportion of the first electrically conductive material from 10% to 90% by volume; and
providing a proportion of the second electrically conductive material from 5% to 50% by volume.

18. The method of claim 16, wherein the pore former has a decomposition and/or vaporization temperature that is below the sintering temperature and the first electrically conductive material has a first melting temperature, wherein the first melting temperature is greater than the sintering temperature, the method further comprising:
heating the green body, prior to step d), to a temperature that is above the decomposition and/or the vaporization temperature of the pore former but lower than the sintering temperature.

19. The method of claim 16, further comprising reworking the sintered body, wherein the reworking is a process selected from a group consisting of grinding, drilling, polishing, milling, turning, applying an electrically conductive paste, and applying electrically conductive solder lines.

20. The method of claim 16, further comprising coating, using a sol-gel method or CVD method, the sintered body with an electrically conductive coating after step d).
